(19) United States
(12) Patent Application Publication
(10) Pub. No.: US 2026/0170402 A1
(43) Pub. Date: Jun. 18, 2026

(54) NEGATIVE COMPLEMENT GENERATION FOR A SET OF VULNERABILITY-FIXING COMMITS

(71) Applicant: SAP SE, Walldorf (DE)

(72) Inventors: Rocio Cabrera Lozoya, Antibes (FR); Antonino Sabetta, Mouans Sartoux (FR); Tommaso Aiello, La Spezia (IT)

(21) Appl. No.: 18/984,448

(22) Filed: Dec. 17, 2024

(51) Int. Cl. G06N 20/00

(52) U.S. Cl. CPC G06N 20/00

(57) ABSTRACT

The disclosure generally describes methods, software, and systems for generation of negative commits. An object representation of a dataset is received, the object representation exposes readily accessible attributes of modified files in the dataset. Positive commits corresponding to source code issue tracking tickets referencing the modified files in the dataset are determined, by processing the readily accessible attributes of modified files in the dataset. Candidate negative commits are determined for each of the positive commits, by processing the source code issue tracking tickets. A matching score between the positive commits and the candidate negative commits is determined. A sorted set of commits including in each set a positive commit and one or more negative commits for the modified files in the dataset is generated, using the matching score. A machine learning model for detection of source code security issues is trained, using the sorted set of negative commits.

### TECHNICAL FIELD

The present disclosure relates to machine learning training. More particularly, implementations of the present disclosure are directed to generation of a negative complement to a dataset of security-relevant commits.

### BACKGROUND

Machine learning models have been applied to various problems in software engineering, such as security analysis of source code and vulnerability detection. Machine learning models trained for security analysis of source code and vulnerability detection are particularly helpful for software providers that generate a vast amount of code requiring analysis. The effectiveness of machine learning-based solutions is dependent on the performance of the machine learning models. In some cases, the success can be limited by the availability of high-quality datasets, which are both scarce and costly to create. Most datasets of vulnerable commits that exist include positive examples. The lack of negative examples further hampers the effectiveness of machine learning training, making it challenging to achieve reliable results.

### SUMMARY

Implementations of the present disclosure are directed to machine learning training. More particularly, implementations of the present disclosure are directed to generation of a negative complement to a dataset of security-relevant commits.

In some implementations, a method includes: receiving an object representation of a dataset, the object representation exposing readily accessible attributes of modified files in the dataset, determining, by processing the readily accessible attributes of modified files in the dataset, a plurality of positive commits corresponding to source code issue tracking tickets referencing the modified files in the dataset, determining, for each of the plurality of positive commits, by processing the source code issue tracking tickets, candidate negative commits, determining a matching score between the positive commits and the candidate negative commits, generating, using the matching score, a sorted set of commits including in each set a positive commit and one or more negative commits for the modified files in the dataset, and training, using the sorted set of negative commits, a machine learning model for detection of source code security issues.

The foregoing and other implementations can each optionally include one or more of the following features, alone or in combination. In particular, implementations can include all of the following features:

In some aspects, combinable with any of the previous aspects, wherein determining the candidate negative commits, includes determining, for each commit of the plurality of commits, that a commit message excludes security-related keywords and a reference to a security ticket. The computer-implemented method includes generating an index of commits in the dataset, and retrieving, for each positive commit, using the index, a set of candidate negative commits corresponding to same files as a respective positive commit. The sorted set of commits is filtered using a similarity threshold. determining a matching score, includes determining a Jaccard similarity coefficient. The readily accessible attributes of the modified files include file names listed in a log message. filtering the modified files in the dataset based on a file type, using file extensions.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient, automatic generation of negative commits that are essential to effective machine-learning training. For generating the negative commits, the described implementation imposes additional constraints on the commits that are chosen as negative complement to a given positive instance. As a result, machine learning models trained on datasets whose negative subset is built as a complement to positive commits enhance the predictive capabilities of machine learning models, because they learn to distinguish commits based on sophisticated characteristics of the actual code changes the commits introduce. As an advantage, the described implementations provide enhanced trained machine learning output accuracy and consistency. As another advantage, the described implementations include an optimization of the generation of negative commits by ranking the negative commits using a matching score. The ranking process facilitates a selection of best candidates that have the most files in common with the respective positive commit, streamlining the generation of the negative commits for machine-learning training.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of negative commits, according to some implementations of the present disclosure.

FIG. 2 is a block diagram of an example system architecture for generation of negative commits, according to some implementations of the present disclosure.

FIG. 3 is a flowchart of an example process for generation of negative commits, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to machine learning training. More particularly, implementations of the present disclosure are directed to generation of a negative complement to a dataset of security-relevant commits. Machine-learning models that identify security-relevant features of source code can be trained using a dataset that introduces or fixes a vulnerability. A portion of the dataset, including positive commits defining security-relevant instances, can be built by mining open-source code repositories. The same repository can be probed to select, for each positive commit, one or more negative commits that are as similar as possible to the respective positive commit, without being security relevant. The candidates of negative commits can be filtered to complete the dataset used to train the machine-learning models. The trained machine-learning models can perform a risk assessment of software systems to identify and correct vulnerabilities before a threat actor can exploit them.

Some traditional negative commit generation protocols can include a random selection of commits from the repository including positive commits. The randomly selected commits can be created as negative commits. The assumption that positive instances are rare is reasonable, as vulnerability-fixing commits are much fewer compared to the rest of the commits in a typical repository. A limitation of the traditional approach for producing negative commits is that it generally selects negative commits with characteristics that differ from the security relevance of the positive commits. For example, vulnerability-fixing commits are generally smaller in size (both in lines of code and number of modified files) compared to the average commit. Additionally, in some projects, vulnerability-fixing commits can include a reference to a source code issue ticket, which is not common for other commits in the same repositories. As a limiting result, machine-learning models trained on datasets with randomly selected negative samples distinguish commits based on irrelevant features, such as size or a presence of source code issue ticket identifiers, rather than actual security-related changes of a source code.

Addressing the limitations of traditional negative commit generation protocols, the negative commit generation described in the present disclosure leads to an increase in training efficiency of machine-learning models and optimized analysis of risks and vulnerabilities of software systems. The described approach imposes selective constraints on the commits that are chosen as negative complements to particular positive commits associated to file changes. The file changes are identified by analyzing a repository and extracting data defining modified, deleted, or added files. The commits associated with changes are processed and filtered to identify negative commits that complement positive commits. The selection of negative commits according to the described approach advantageously facilitates effective machine-learning training. Using the described approach, machine learning models are trained on datasets including negative commits that complement positive commits that facilitate learning of security relevant classification based on sophisticated characteristics of the actual source code changes.

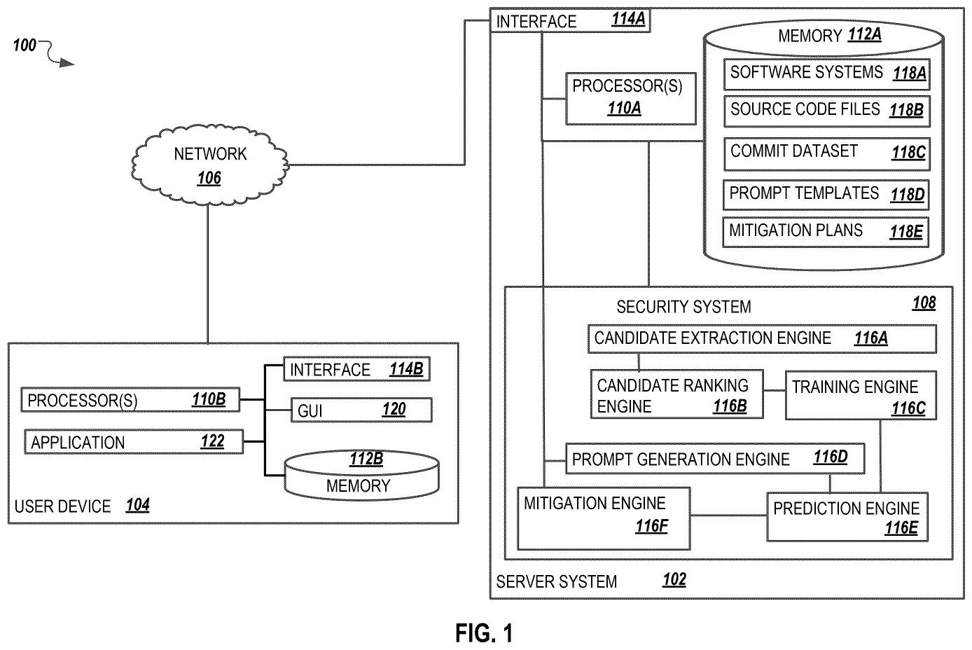

FIG. 1 is a block diagram of an example system 100 for generation of negative commits, according to some implementations of the present disclosure. Specifically, the illustrated example system 100 includes or is communicably coupled with a server system 102, an end-user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services including generation of negative complement services for a dataset of security-relevant commits and provides such services to any number of end-user devices 104 (e.g., the user device 104 over the network 106). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes associated with generation of a negative complement to a dataset of security-relevant commits, including implementation of mitigation plans. For example, the server system 102 includes a security system 108, a processor 110A, a memory 112A, and an interface 114A.

The security system 108 can include a candidate extraction engine 116A, a candidate ranking engine 116B, a training engine 116C, a prompt generation engine 116D, a prediction engine 116E, and a mitigation engine 116F. The security system 108 is coupled to the processor 110A, the memory 112A, and the interface 114A for generation of negative commits using data stored in the memory 112A. The memory 112A can include software systems 118A, source code files 118B, commit dataset 118C, prompt templates 118D, and mitigation plans 118E.

For example, as user devices 104 generate requests for generation of a negative complement to a dataset of security-relevant commits, the security system 108 can be used to generate commit datasets corresponding to changes applied to the source code files 118B of a particular software system 118A. The source code files 118B can be processed by the candidate extraction engine 116A to determine security relevant candidate negative commits. The candidate extraction engine 116A can transmit the security relevant candidate negative commits to the candidate ranking engine 116B.

The candidate ranking engine 116B can rank the security relevant candidate negative commits to select negative commits that complement the positive commits and generate the commit dataset 118C. The candidate ranking engine 116B can send the commit dataset 118C to the training engine 116C and to the memory 112A for storage. The training engine 116C can execute training of machine learning models in the detection of security-relevant commits. The training engine 116C can transmit a confirmation of training completion to the prediction engine 116E, which can process prompts generated, using a prompt template 118D, by the prompt generation engine 116D to identify security vulnerabilities of the software systems 118A associated with changes to the source code files 118B.

The prediction engine 116E can use the trained machine learning model to produce textual descriptions of security threats and mitigations associated with the path corresponding to the prompt and send them to the mitigation engine 116F. The mitigation engine 116F can process the textual descriptions of threats and mitigations to generate a mitigation plan that can be displayed on the GUI 120 and stored in the memory 112A.

The components of the security system 108, including the training engine 116C, the prompt generation engine 116D, the prediction engine 116E, and the mitigation engine 116F can include machine learning (e.g., generative AI) functionality for optimizing generation and application of negative commits for security vulnerability identification and mitigation. The prediction engine 116E can use a prediction model to process the prompt and use commits corresponding to the prompt to identify security vulnerabilities and send them to the mitigation engine 116F.

The prediction engine 116E can include a prediction model, such as LLMs (e.g., deep learning models) trainable on vast quantities of unlabeled data. The LLMs can include GPT 35 TURBO, GPT 35 TURBO-16K, GPT-4, or GPT-4-32K. The prediction engine 116E can be further optimized by efficient training of the adjusted weights of the prediction model using filtered negative commits complementing positive commits. The prediction engine 116E can optimize machine learning training using ranked negative commits that effectively increase an accuracy of the prediction engine 116E.

In general, the end-user device 104 includes an electronic computer device operable to receive, transmit, process, and store any appropriate data associated with the system 100 of FIG. 1. The end-user device 104 is generally intended to encompass any client computing device such as a laptop/notebook computer, wireless data port, smart phone, personal data assistant (PDA), tablet computing device, one or more processors within these devices, or any other suitable processing device. The end-user device 104 includes an interface 114B, a processor 110B, a memory 112B, and a graphical user interface (GUIs) 118A. The end-user device 104 can include one or more applications 122. The application 122 can be any type of application that allows a user device to request and view content on the user device (e.g., generate a request for generation of a negative complement to a dataset of security-relevant commits). In some implementations, an application 122 can use parameters, metadata, and other data to access the security system 108 from the server system 102. In some instances, an application 122 can be an agent or client-side version of the one or more enterprise applications running on an enterprise server (not shown).

In accordance with implementations of the present disclosure, the application 122 includes a digital assistant that enables interactions with the user device 104. For example, and as described in further detail herein, the digital assistant of the user device 104 can receive a query. In some examples, one or more query responses can include data that is presented as a graphical representation in the GUI 120. In accordance with implementations of the present disclosure, the digital assistant can present data as a graphical representation in a popover container within a window therein. In some examples, the popover container is provided as an iframe-based container and the digital assistant communicates with the popover container using remote procedure calls.

As described in further detail herein, a user can input a query to the digital assistant and the digital assistant can receive a response to the query. In accordance with implementations of the present disclosure, the response can include a display of a mitigation plan 118E. In some examples, the response can include a graphical representation of the commit dataset 118C with annotations including negative commits complimenting the positive commits identified by the security system 108 and is displayed in a UI of the digital assistant. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any or all of the components of the example system 100, both hardware or software (or a combination of hardware and software), may interface with each other or the interface(s) 114A, 114B (or a combination of both) over the network 106 for generation of a negative complement to a dataset of security-relevant commits. The functionality of the end-user device 104 can be accessible for all service consumers using the application 122 that transmits prompts to the security system 108 to generate mitigation plans 118E.

For example, the end-user device 104 may include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122 or the administrative application 133, respectively. In particular, the GUI 120 can be used to view and navigate various Web pages. The GUI 120 can provide the user with an efficient and user-friendly presentation of business data provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the end-user device 104 can be a central processing unit (CPU), an application specific integrated circuit (ASIC), a field-programmable gate array (FPGA), or another suitable component. Each processor 110A, 110B included in the end-user device 104 executes instructions and manipulates data to perform the operations of the end-user device 104, respectively. Specifically, each processor 110A, 110B included in the end-user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the end-user device 104). Specifically, each processor 110A, 110B executes the functionality required to receive and respond to requests from the respective system (the server system 102, the end-user device 104), for example.

Interfaces 114A, 114B are used by the server system 102, the end-user device 104, respectively, for communicating with other systems in a distributed environment—including within the system 100—connected to the network 106. Generally, the interfaces 114A, 114B each include logic encoded in software and/or hardware in a suitable combination and operable to communicate with the network 106. More specifically, the interfaces 114A, 114B may each include software supporting one or more communication protocols associated with communications such that the network 106 or interface's hardware is operable to communicate physical signals within and outside of the illustrated system 100.

The memory 112A, 112B may include any type of memory or database module and may take the form of volatile and/or non-volatile memory including, without limitation, magnetic media, optical media, random access memory (RAM), read-only memory (ROM), removable media, or any other suitable local or remote memory component. The memory 112A, 112B may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, or the end-user device 104, respectively.

There can be any number of end-user devices 104 and API provider systems 110 associated with, or external to, the system 100. Additionally, the example system 100 can include one or more additional user devices external to the illustrated portion of system 100 that are capable of interacting with the system 100 via the network(s) 106. Further, the term “client,” “user device,” and “user” can be used interchangeably as appropriate without departing from the scope of the disclosure. Moreover, while user device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single end-user device 104, the system 100 can be implemented using a single, stand-alone computing device, two or more servers 102, or multiple user devices. The server system 102, and the end-user device 104 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 may also include or be communicably coupled with an e-mail server, a Web server, a caching server, a streaming data server, and/or another suitable server.

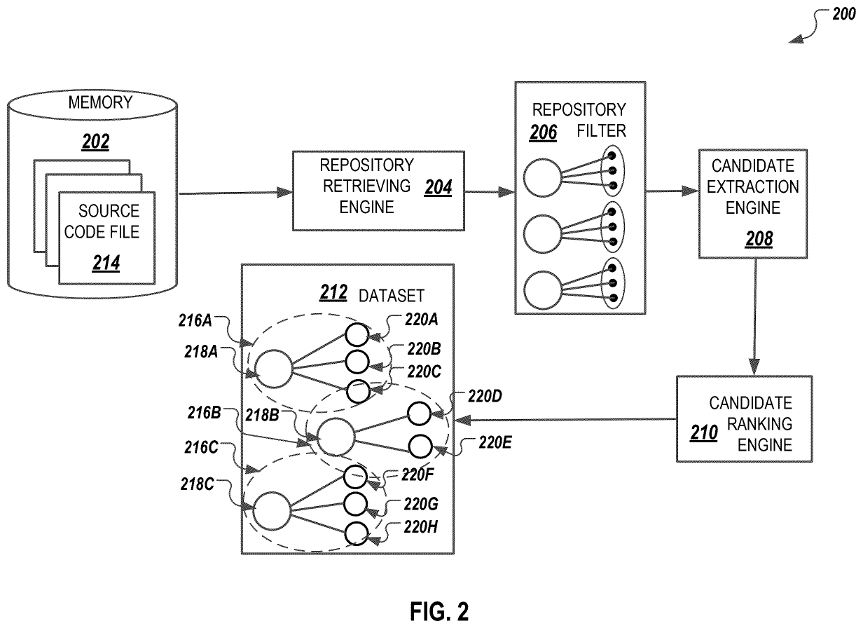

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate. The communication between the end user device 104 and the server system 102 can include several different communication protocols configured to optimize generation of negative commits, as further described in detail with reference to FIGS. 2-4.

FIG. 2 is a block diagram of an example system architecture 200 for generation of negative commits, according to some implementations of the present disclosure. The example system architecture 200 includes a memory 202 (e.g., memory 112A described with reference to FIG. 1), a repository retrieving engine 204, a repository filter 206, a candidate extraction engine 208, a candidate ranking engine 210, and a dataset 212.

The memory 202 can include a collection of source code files 214. The source code files 214 can be files with a predetermined set of file extensions (e.g., “java,” “.cpp,” “.py,” “.js,” “.cs,” “.rb,” “.php,” “.html,” “.css,” “.ts,” “.swift,” “.kt,” “.go,” “.rs,” “.m,” “.sh,” and “.pl”), that are indicative of code changes. The source code files 214 can include changed source code files of software systems or new source code files generated for the software systems. The changed source code files refer to source code files that were previously stored in the memory 202 and were modified. The modifications of the changed source code files include additions and deletions of code segments. The modifications can range from minor changes to substantial changes, reflecting updates, bug fixes, or enhancements to the software systems. New source code files are entirely new additions to the software systems, being stored in the memory 202, representing new features or components being integrated into the existing codebase. The setup of the memory 202 facilitate efficient tracking and management of changes to the source code files 214 and retrieval of the source code changes, by the repository retrieving engine 204.

The repository retrieving engine 204 can process a data identifying source code changes as input to identify commit samples. The repository retrieving engine 204 can identify the repositories stored in the memory 202 that appear in the dataset, and clone the identified the repositories locally. For each commit that is locally stored, the repository retrieving engine 204 can generate an object representation that exposes readily accessible attributes of the source code changes. The readily accessible attributes of the source code changes can include a set of file names corresponding to the commit, log message, timestamps, changed lines, tags, branch information, parent commits, commit hashes, and author information. The file names indicate names of the files that were modified in the commit. The commit log message can be a message associated with the commit, describing a purpose or a nature of the changes. The author information can include details about an author of the commit, such as a name or an identifier. The timestamp can include a date and time when the commit was made. The line changes can include identifiers of lines added and/or deleted, search as a number of lines of code that were added or removed in the commit. The commit hash can include a unique identifier for the commit. The branch information can identify a branch of the repository, where the commit was made. The parent commits can be references to the previous commits in the repository's history. The tags can be any tags associated with the commit, which can be used for versioning or categorization. The repository retrieving engine 204 can transmit the commit samples to the repository filter 206.

The repository filter 206 processes the commit samples using the readily accessible attributes of the source code changes to obtain a list of the commits in the repository. The repository filter 206 can filter the commit samples by ignoring commits that change particular types of files, such as documentation, stylesheets, images, and other security irrelevant changes. The repository filter 206 can transmit the commit list to the candidate extraction engine 208.

The candidate extraction engine 208 can filter out the commit list including an initial set of candidate negative commits for each positive commit, to obtain a filtered list of candidate negative commits. The candidate extraction engine 208 can remove, from the initial set of candidate negative commits, negative commits with log messages that match a suitable regex that corresponds to obvious well-known security-related terms. The candidate extraction engine 208 can remove, from the initial set of candidate negative commits, negative commits that do not include a reference to a security tracking system. The filtered list of candidate negative commits can be indexed. The candidate extraction engine 208 can transmit the filtered list of candidate negative commits to the candidate ranking engine 210.

The candidate ranking engine 210, for each positive commit, creates a ranking to generate a sorted set of (negative) candidates based on the corresponding source files. The ranking can be based on a matching score between the candidate negative commits and a respective positive commit. The candidate negative commits with highest matching score are the candidate negative commits that have the most files in common with the respective positive commit. In some implementations, candidate negative commits with matching scores below a similarity threshold are removed from the dataset 212.

The dataset 212 can include sorted sets of matching commits 216A, 216B, 216C, each set of commits including a positive commit 218A, 218B, 218C and one or more complementing negative commits 220A, 220B, 220C, 220D, 220E, 220F, 220G, 220H, identified by the candidate ranking engine 210. The dataset 212 can be stored, by the memory 202, as indexed and grouped commits, indicative of a relationship between the one or more negative commits 220A, 220B, 220C, 220D, 220E, 220F, 220G, 220H and the respective positive commit 218A, 218B, 218C. The sorted sets of matching commits 216A, 216B, 216C can be stored together with corresponding textual descriptions of issue-related terms. The example system architecture 200 includes an innovative generation of negative commits 220A, 220B, 220C, 220D, 220E, 220F, 220G, 220H complementing positive commit 218A, 218B, 218C for robust training of machine learning models to identify diverse threats and mitigations of a software system. The example system architecture 200 provides the sorted sets of matching commits 216A, 216B, 216C for accurate identification of threats and mitigation plans applicable to a large variety of software systems.

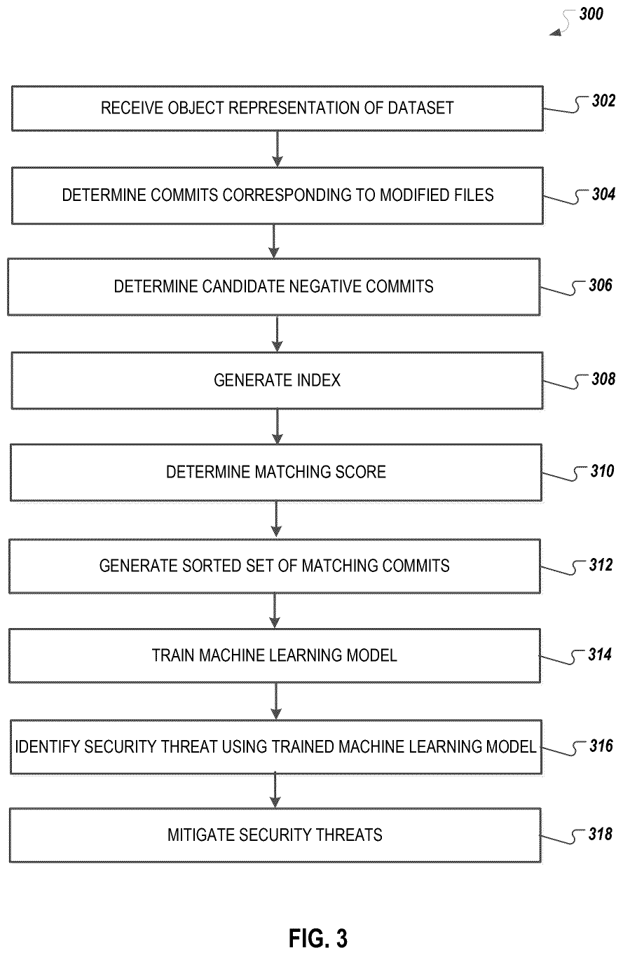

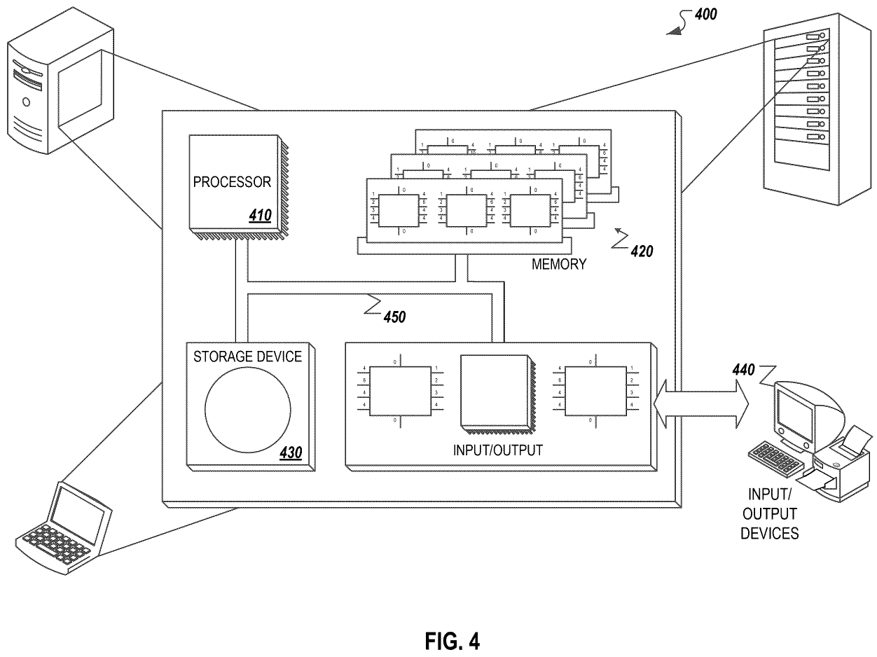

FIG. 3 is a flowchart of an example process 300 for generation of negative commits, according to some implementations of the present disclosure. The example process 300 can be performed by any component of the example system 100, described with reference to FIG. 1 or the example system architecture 200, described with reference to FIG. 2 or the example computing system 400, described with reference to FIG. 4. For clarity of presentation, the description that follows generally describes the example process 300 in the context of the systems described with reference to FIGS. 1, 2, and 4.

At 302, a representation of a commit object of a starting dataset P is retrieved, by a processor of a user device or by a processor of a server system. The starting dataset P includes a list of commit messages that contain several key attributes to provide context and facilitate analysis of changes applied to modified files. The modified files can be listed in the list of commit messages including their respective file extensions (e.g., “java,” “.cpp,” “.py”). The file extensions can be used to apply a commit filtering, to ignore commits that only change other types of files, such as documentation, stylesheets, images, and the like. The object representation exposes readily accessible attributes of the modified files in the starting dataset P according to a commit message structure.

At 304, commits corresponding to modified files in the data set are determined, by the processor using the commit message structure. The starting dataset P to be complemented is assumed to only contain positive instances and it is processed to identify the positive commits. In some implementations, each commit message, in the filtered list of commit messages, is processed to perform a check to determine whether the respective commit message contains security related key attributes. In response to determining that a security related key attribute is identified as being a commit that is in the in the pool of possible candidates, a verification is executed using the commit message structure. Security related keywords can be discarded. The source code issue tracking tickets referenced in the commit message, can be identified in association with security relevant keywords that can be indicative of be a fixed commit.

At 306, candidate negative commits are determined, by the processor, starting from the positive commits. For each positive commit, the respective source code issue tracking ticket is accessed and processed to determine negative commits unrelated to security related issues. For example, for each positive commit, pⁱ, in the starting dataset P, one or more negative commits Nᵢ={nⱼ}, j=1 . . . k are selected from the same repository rᵢ as pⁱ that are as similar as possible to the positive one but are negative (e.g., are not security-relevant) are selected. The parameter k indicates a targeted number of negative commits to be determined for each positive commit. The parameter k can be selected to control a size of commits. For example, k can be selected to restrict the size of the commits to process based on the number of files it modifies, to avoid processing overly large commits. If only one negative commit is to be obtained for each positive commit, the parameter k is set to 1 and if multiple negative commits are selected to be obtained for each positive commit, the parameter k is set to be an integer greater than 1. The negative commits can be filtered to remove a portion of the candidate negative commits corresponding to known security-related terms and to generate filtered negative commits. Filtering the candidate negative commits can include determining, for each commit of the plurality of commits, that a commit message excludes security-related keywords and a reference to a security ticket.

At 308, the positive commits in P are processed, by the processor, to construct an index. The index identifies each processed modified file corresponding to at least one positive commit of P and the set of negative commits (from the same repository as the respective positive commit) that are associated with the respective file. A candidate negative commit is included in the index only if (a) it is in not in the set of positive commits P and (b) it passed filtering (excludes security-related keywords and a reference to a security ticket). The commit message of the candidate negative commit is checked using a regular expression to determine in response to determining that it contains security-related keywords. In response to determining that the commit passed the check, it is verified whether the commit message includes a reference to a security-tracking ticket (e.g. Jira ticket or GitHub issue). In response to determining that the commit message does not include a reference to a security-tracking ticket, the commit is discarded and is not included in the index. In response to determining that the commit message includes a reference to a security-tracking ticket, the source code issue ticket is retrieved, and it is determined whether the issue is flagged as security-relevant. The issue is flagged as security-relevant if it is explicitly labeled as such, or if its textual content matches a suitable regular expression, similarly as with the commit message). In response to determining that the source code issue ticket is indeed security-related, the commit is discarded. In response to determining that a candidate negative commit passes the filtering steps, the candidate negative commit is included in the index. Each candidate negative commit can be annotated in the index with the set of associated modified files.

At 310, a matching score between the positive commits and the filtered negative commits is determined, by the processor. For each positive commit, a set of candidate negative commits corresponding to same files as a respective positive commit is retrieved, using the index. The commits can be ranked by computing the matching score between pᵢ and each candidate negative nⱼ, where i and j are numerical integers from 1 to k, a maximum number within the respective set of values of positive commits and filtered negative commits. Considering Fₚ_{ᵢ} the set of files touched by pᵢ, and Fₙ_{ⱼ} the set of files touched by nⱼ, the matching score between pᵢ and nⱼ can be computed with a suitable matching score. For example, the matching score can be defined as:

$$M ( {p}_{i} , {n}_{j} ) = \vert {F}_{{p}_{i}} ⋂ {F}_{{n}_{j}} \vert - \vert {F}_{{p}_{i}} \backslash {F}_{{n}_{j}} \vert - \vert {F}_{{n}_{j}} \backslash {F}_{{p}_{i}} \vert$$

Fₚ_{ᵢ} represents the set of features associated with the negative commit nⱼ. |Fₚ_{ᵢ}∩Fₙ_{ⱼ}| represents the cardinality (number of elements) of the intersection of the two sets, meaning the number of features that are common to both pᵢ and nⱼ. Fₚ_{ᵢ}\Fₙ_{ⱼ} represents the cardinality of the difference between the two sets, meaning the number of features that are in pᵢ but not in nⱼ. Fₙ_{ⱼ}\Fₚ_{ᵢ} represents the cardinality of the difference between the two sets, meaning the number of features that are in nⱼ but not in pᵢ. The matching score M(pᵢ, nⱼ) calculates a value based on the features of the positive commit pᵢ and the negative commit nⱼ. The matching score M(pᵢ, nⱼ) measures the similarity between the positive commit pᵢ and the negative commit nⱼ by considering the common features and penalizing for the features that are unique to each instance. A higher value of matching score M(pᵢ, nⱼ) indicates a greater similarity between the two commits, while a lower value indicates less similarity.

As another example, the matching score J(pᵢ, nⱼ) can be defined or using the Jaccard similarity coefficient as:

$$J ( {p}_{i} , {n}_{j} ) = \frac{\vert {F}_{{p}_{i}} ⋂ {F}_{{n}_{j}} \vert}{\vert {F}_{{p}_{i}} ⋂ {F}_{{n}_{j}} \vert}$$

The matching score J(pᵢ, nⱼ) defined using the Jaccard similarity coefficient measures the similarity between the two commits by comparing their sets of features. Fₚ_{ᵢ} represents the set of features associated with the positive commit pᵢ. En is the set of features associated with the negative commit nⱼ. Fₚ_{ᵢ}∩Fₙ_{ⱼ} represents the cardinality (number of elements) of the intersection of the two sets, which is the number of features common to both the positive commit pᵢ and the negative commit nⱼ. Fₚ_{ᵢ}∪Fₙ_{ⱼ} represents the cardinality of the union of the two sets, which is the total number of unique features present in either the positive commit pᵢ or the negative commit nⱼ. The Jaccard similarity coefficient is a ratio that ranges from 0 to 1, where 0 indicates no shared features between the positive commit pᵢ and the negative commit nⱼ and 1 indicates that all features are shared between the positive commit pᵢ and the negative commit nⱼ.

At 312, sorted sets of matching commits is generated, by the processor. Each set of the sorted sets of matching commits includes a positive commit pᵢ and one or more negative commits nⱼ, each having a respective matching score. The sorted sets of matching commits can be filtered using a threshold. For example, the negative commits can be ranked according to the matching score of choice and negative commits with a matching score below a threshold can be removed from the sorted set of matching commits.

At 314, a machine learning model is trained using the sorted sets of matching commits. The machine learning model can include a large language model being trained to detect security-relevant commits based only on changes made in committed source codes. The machine learning model can include LLMs (e.g., deep learning models) trained using the sorted set of matching commits and mitigated threats mapped to source code changes. The machine learning model can be trained, including an adjustment of weights according to different system types, for vulnerability identification and threat modeling.

At 316, a list of threats and a mitigation plan is received from the trained prediction model, in response to processing a prompt indicative of source code changes. The prediction model executes threat analysis using the positive and negative commits. The list of threats and the mitigation plan can be received as textual content and graphical content. The graphical content can be displayed by a GUI of a user device. In some examples, the graphical representation can be provided as a web-based rendering using a web rendering runtime that is built into the popover container (e.g., iframe). In some examples, the graphical representation is compatible with a UI framework of the popover container. The mitigation plan can be provided as a set of recommendations or instructions for changes in the system design.

At 318, a mitigation plan is automatically executed, by the processor. The mitigation plan can include a modification of a source code segment and/or an adjustment of data flow according to a secure sequence of data transmission between the system nodes to perform actions involving the source code segment. The data flow can be defined by templates indicating which components can be modified. The templates can correspond to particular security communication scenarios. An application invoking a sequence of the adjusted data flow can be executed. The execution of the data flow can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The output of the automatically embed API calls in source code can be displayed by a graphical user interface.

The example process 300 for generation of negative commits provides several significant advantages for machine learning training by efficiently generating negative commits. By imposing additional constraints on the selection of negative commits to complement positive commits, the example process 300 ensures that machine learning models are trained on datasets that enhance their predictive capabilities. The described machine learning models learn to distinguish commits based on sophisticated characteristics of the actual code changes, leading to improved accuracy and consistency in the trained machine learning outputs. The example process 300 optimizes the generation of negative commits by ranking them using a matching score. The example process 300 advantageously includes a ranking process that selects the best candidate negative commits with the most files in common with the respective positive commit, streamlining the generation of negative commits and further enhancing the effectiveness of machine learning training. The described training results in a more robust and reliable model, capable of making more precise predictions.

FIG. 4 is a block diagram of an example computing system 400 used to provide computational functionalities associated with described algorithms, methods, functions, processes, flows, and procedures, for example, as described with reference to FIG. 3, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the security system 108, described with reference to FIG. 1. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method, comprising: receiving an object representation of a dataset, the object representation exposing readily accessible attributes of modified files in the dataset; determining, by processing the readily accessible attributes of modified files in the dataset, a plurality of positive commits corresponding to source code issue tracking tickets referencing the modified files in the dataset; determining, for each of the plurality of positive commits, by processing the source code issue tracking tickets, candidate negative commits; determining a matching score between the positive commits and the candidate negative commits; generating, using the matching score, a sorted set of commits comprising in each set a positive commit and one or more negative commits for the modified files in the dataset; and training, using the sorted set of negative commits, a machine learning model for detection of source code security issues.

Example 2. The computer-implemented method of the preceding example, wherein determining the candidate negative commits, comprises: determining, for each commit of the plurality of commits, that a commit message excludes security-related keywords and a reference to a security ticket.

Example 3. The computer-implemented method of any of the preceding examples, comprising: generating an index of commits in the dataset; and retrieving, for each positive commit, using the index, a set of candidate negative commits corresponding to same files as a respective positive commit.

Example 4. The computer-implemented method of any of the preceding examples, wherein the sorted set of commits is filtered using a similarity threshold.

Example 5. The computer-implemented method of any of the preceding examples, wherein determining a matching score, comprises: determining a Jaccard similarity coefficient.

Example 6. The computer-implemented method of any of the preceding examples, wherein the readily accessible attributes of the modified files comprise file names listed in a log message.

Example 7. The computer-implemented method of any of the preceding examples, comprising: filtering the modified files in the dataset based on a file type, using file extensions.

Example 8. A computer-implemented system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving an object representation of a dataset, the object representation exposing readily accessible attributes of modified files in the dataset; determining, by processing the readily accessible attributes of modified files in the dataset, a plurality of positive commits corresponding to source code issue tracking tickets referencing the modified files in the dataset; determining, for each of the plurality of positive commits, by processing the source code issue tracking tickets, candidate negative commits; determining a matching score between the positive commits and the candidate negative commits; generating, using the matching score, a sorted set of commits comprising in each set a positive commit and one or more negative commits for the modified files in the dataset; and training, using the sorted set of negative commits, a machine learning model for detection of source code security issues.

Example 9. The computer-implemented system of the preceding example, wherein determining the candidate negative commits, comprises: determining, for each commit of the plurality of commits, that a commit message excludes security-related keywords and a reference to a security ticket.

Example 10. The computer-implemented system of any of the preceding examples, the operations comprising: generating an index of commits in the dataset; and retrieving, for each positive commit, using the index, a set of candidate negative commits corresponding to same files as a respective positive commit.

Example 11. The computer-implemented system of any of the preceding examples, wherein the sorted set of commits is filtered using a similarity threshold.

Example 12. The computer-implemented system of any of the preceding examples, wherein determining a matching score, comprises: determining a Jaccard similarity coefficient.

Example 13. The computer-implemented system of any of the preceding examples, wherein the readily accessible attributes of the modified files comprise file names listed in a log message.

Example 14. The computer-implemented system of any of the preceding examples, the operations comprising: filtering the modified files in the dataset based on a file type, using file extensions.

Example 15. A non-transitory computer-readable media encoded with a computer program, the computer program comprising instructions that when executed by one or more computers cause the one or more computers to perform operations comprising: receiving an object representation of a dataset, the object representation exposing readily accessible attributes of modified files in the dataset; determining, by processing the readily accessible attributes of modified files in the dataset, a plurality of positive commits corresponding to source code issue tracking tickets referencing the modified files in the dataset; determining, for each of the plurality of positive commits, by processing the source code issue tracking tickets, candidate negative commits; determining a matching score between the positive commits and the candidate negative commits; generating, using the matching score, a sorted set of commits comprising in each set a positive commit and one or more negative commits for the modified files in the dataset; and training, using the sorted set of negative commits, a machine learning model for detection of source code security issues.

Example 16. The non-transitory computer-readable media of the preceding example, wherein determining the candidate negative commits, comprises: determining, for each commit of the plurality of commits, that a commit message excludes security-related keywords and a reference to a security ticket.

Example 17. The non-transitory computer-readable media of any of the preceding examples, the operations comprising: generating an index of commits in the dataset; and retrieving, for each positive commit, using the index, a set of candidate negative commits corresponding to same files as a respective positive commit.

Example 18. The non-transitory computer-readable media of any of the preceding examples, wherein the sorted set of commits is filtered using a similarity threshold, wherein determining a matching score, comprises: determining a Jaccard similarity coefficient.

Example 19. The non-transitory computer-readable media of any of the preceding examples, wherein the readily accessible attributes of the modified files comprise file names listed in a log message.

Example 20. The non-transitory computer-readable media of any of the preceding examples, the operations comprising: filtering the modified files in the dataset based on a file type, using file extensions.

1. A computer-implemented method, comprising:
receiving an object representation of a dataset, the object representation exposing readily accessible attributes of modified files in the dataset;
determining, by processing the readily accessible attributes of modified files in the dataset, a plurality of positive commits corresponding to source code issue tracking tickets referencing the modified files in the dataset;
determining, for each of the plurality of positive commits, by processing the source code issue tracking tickets, candidate negative commits;
determining a matching score between the positive commits and the candidate negative commits;
generating, using the matching score, a sorted set of commits comprising in each set a positive commit and one or more negative commits for the modified files in the dataset; and
training, using the sorted set of negative commits, a machine learning model for detection of source code security issues.

2. The computer-implemented method of claim 1, wherein determining the candidate negative commits, comprises:
determining, for each commit of the plurality of commits, that a commit message excludes security-related keywords and a reference to a security ticket.

3. The computer-implemented method of claim 2, comprising:
generating an index of commits in the dataset; and
retrieving, for each positive commit, using the index, a set of candidate negative commits corresponding to same files as a respective positive commit.

4. The computer-implemented method of claim 1, wherein the sorted set of commits is filtered using a similarity threshold.

5. The computer-implemented method of claim 4, wherein determining a matching score, comprises:
determining a Jaccard similarity coefficient.

6. The computer-implemented method of claim 1, wherein the readily accessible attributes of the modified files comprise file names listed in a log message.

7. The computer-implemented method of claim 1, comprising:
filtering the modified files in the dataset based on a file type, using file extensions.

8. A computer-implemented system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving an object representation of a dataset, the object representation exposing readily accessible attributes of modified files in the dataset;
determining, by processing the readily accessible attributes of modified files in the dataset, a plurality of positive commits corresponding to source code issue tracking tickets referencing the modified files in the dataset;
determining, for each of the plurality of positive commits, by processing the source code issue tracking tickets, candidate negative commits;
determining a matching score between the positive commits and the candidate negative commits;
generating, using the matching score, a sorted set of commits comprising in each set a positive commit and one or more negative commits for the modified files in the dataset; and
training, using the sorted set of negative commits, a machine learning model for detection of source code security issues.

9. The computer-implemented system of claim 8, wherein determining the candidate negative commits, comprises:
determining, for each commit of the plurality of commits, that a commit message excludes security-related keywords and a reference to a security ticket.

10. The computer-implemented system of claim 9, the operations comprising:
generating an index of commits in the dataset; and
retrieving, for each positive commit, using the index, a set of candidate negative commits corresponding to same files as a respective positive commit.

11. The computer-implemented system of claim 8, wherein the sorted set of commits is filtered using a similarity threshold.

12. The computer-implemented system of claim 11, wherein determining a matching score, comprises:
determining a Jaccard similarity coefficient.

13. The computer-implemented system of claim 8, wherein the readily accessible attributes of the modified files comprise file names listed in a log message.

14. The computer-implemented system of claim 8, the operations comprising:
filtering the modified files in the dataset based on a file type, using file extensions.

15. A non-transitory computer-readable media encoded with a computer program, the computer program comprising instructions that when executed by one or more computers cause the one or more computers to perform operations comprising:
receiving an object representation of a dataset, the object representation exposing readily accessible attributes of modified files in the dataset;
determining, by processing the readily accessible attributes of modified files in the dataset, a plurality of positive commits corresponding to source code issue tracking tickets referencing the modified files in the dataset;
determining, for each of the plurality of positive commits, by processing the source code issue tracking tickets, candidate negative commits;
determining a matching score between the positive commits and the candidate negative commits;
generating, using the matching score, a sorted set of commits comprising in each set a positive commit and one or more negative commits for the modified files in the dataset; and
training, using the sorted set of negative commits, a machine learning model for detection of source code security issues.

16. The non-transitory computer-readable media of claim 15, wherein determining the candidate negative commits, comprises:
determining, for each commit of the plurality of commits, that a commit message excludes security-related keywords and a reference to a security ticket.

17. The non-transitory computer-readable media of claim 16, the operations comprising:
generating an index of commits in the dataset; and
retrieving, for each positive commit, using the index, a set of candidate negative commits corresponding to same files as a respective positive commit.

18. The non-transitory computer-readable media of claim 15, wherein the sorted set of commits is filtered using a similarity threshold, wherein determining a matching score, comprises:
determining a Jaccard similarity coefficient.

19. The non-transitory computer-readable media of claim 15, wherein the readily accessible attributes of the modified files comprise file names listed in a log message.

20. The non-transitory computer-readable media of claim 15, the operations comprising:
filtering the modified files in the dataset based on a file type, using file extensions.
